(19) United States
(12) Patent Application Publication
(10) Pub. No.: US 2014/0007211 A1
(43) Pub. Date: Jan. 2, 2014

(54) SYSTEM, METHOD AND COMPUTER READABLE RECORDING MEDIUM FOR LINKING TELEVISION AND SMART PHONE USING IMAGE AUTHENTICATION KEY

(71) Applicant: NHN Corporation, Seongnam-si (KR)

(72) Inventors: Byoung Seok YANG, Seongnam-si (KR); Sae Rin KIM, Seongnam-si (KR); Man Ho WON, Seongnam-si (KR)

(21) Appl. No.: 13/927,697

(22) Filed: Jun. 26, 2013

(30) Foreign Application Priority Data
Jun. 27, 2012 (KR) 10-2012-0069252

(51) Int. Cl. H04L 29/06

(52) U.S. Cl. CPC H04L 63/08
USPC 726/7

(57) ABSTRACT

Disclosed herein is a system for linking a smart TV and a smart phone of a user using an image authentication key capable of registering the smart phone in the smart TV using an authentication key in an image form such as a quick response (QR) code, or the like. The system includes: a service server configured to generate an image authentication key comprising access information, configured to provide the image authentication key to the smart TV, and configured to provide terminal information from a user terminal to the smart TV, to link the smart TV and the user terminal; a terminal access application installed in a smart TV configured to request the image authentication key from the service server, configured to receive the image authentication key, and configured to display the received image authentication key on a screen; and a user terminal configured to scan and analyze the image authentication key displayed on the smart TV, and configured to transmit terminal information to the service server using the access information.

### CROSS-REFERENCE TO RELATED APPLICATIONS

This application claims priority from and the benefit of Korean Patent Application No. 10-2012-0069252, filed on Jun. 27, 2012, which is hereby incorporated by reference for all purposes as if fully set forth herein.

### BACKGROUND

1. Field

The present invention relates to a system for linking a smart television (TV) and a smart phone, and more particularly, to a system, a method, and a computer readable recording medium for linking a smart TV and a smart phone using an image authentication key capable of registering the smart phone in the smart TV using an authentication key in an image form, such as, a quick response (QR) code, or the like.

2. Discussion of the Background

Recently several sizes and kinds of display apparatuses have been released. Further, various hand-held personal terminals have emerged. For example, apparatuses including display units having various sizes, such as a terminal in a pad form, a 7-inch tablet personal computer (PC), a 10-inch tablet PC, and the like, as well as the smart phone, have been released.

A television (TV) displays a received terrestrial wave or cable broadcasting signal and provides an interactive function with a user and various additional services using the Internet.

In addition, in order to receive a digital broadcasting, an apparatus called a set top box (STB) as well as the TV is additionally required. The set top box is connected with the TV and receives signals input from the outside, appropriately converts the signals, and then displays contents of the signals on the TV. The set top box is a home communication terminal required to use the next-generation bidirectional multimedia communication service (so-called interactive TV), such as, a video on demand (VOD), a home shopping, a network game, and the like, is called a ‘subscriber signal converting apparatus.’ The set top box is used with a TV set. The set top box is connected with a network of a bidirectional TV, a phone, a video transmission service (for example, a video dial tone provided by a regional phone company of the United State), or the like, and is connected with a TV, or the like, at home and is used.

The set top box receives and converts a video signal, and communicates with a video server installed at a phone company or a cable TV (CATV) station. In an interactive TV market, manufacturers of communication devices, computers, and home appliances have been in competition in manufacturing and selling the set top box.

The set top box needs a tuner embedded therein, and an example of an apparatus providing an external signal to the set top box includes an Ethernet cable, a satellite wave or terrestrial wave receiving antenna, a coaxial cable, a telephone line, an analog very high frequency (VHF) or ultra-high frequency (UHF) antenna, and the like. An example of contents capable of being received through the above-mentioned apparatus may include video, audio, an Internet web page, a game, and the like.

As described above, information services as well as broadcasting information may be provided in the TV through the set top box linked to the Internet and be selected and controlled through bidirectional communication with a user. In order to facilitate a selection signal input by the user, a function of a remote controller needs to be variously expanded, and a convenient interface has been demanded.

In addition, the TV in which a function of the set top box is embedded enables terrestrial broadcasting to be viewed and is connected with the Internet to enable computer functions, such as, a video on demand (VOD), a game, a video call, application utilization, and the like. A general TV may also utilize the above-mentioned function through a connection with the set top box. When considering that a long period of time is needed to replace a TV, or the like, markets of the TV and the set top box have been developed together.

Therefore, as one of methods for utilizing a computer function using a TV in which the functions of the set top box described above are embedded, a method of effectively registering a smart phone in a TV and linking the smart phone and the TV to each other to control the TV by the registered smart phone and interwork and execute various applications has been demanded. However, currently, only an authentication method for a client terminal itself is has been disclosed in the related art, and a method of registering and authenticating a separate user terminal (for example, a smart phone) in a client terminal (for example, TV) has not been disclosed.

### SUMMARY

Aspects of the present invention provide a system, a method, and a computer readable recording medium for linking a smart television (TV) and a smart phone using an image authentication key capable of registering the smart phone with the smart TV by displaying the image authentication key provided from a service server through the smart TV and scanning the image authentication key in the smart phone to transmit the image authentication key to the service server.

Aspects of the present invention provide a system, a method, and a computer readable recording medium for linking a smart TV and a smart phone using an image authentication key capable of registering the smart phone in the smart TV using the image authentication key and performing log-in through the smart phone pre-registered in the smart TV at the time of executing a smart TV application requiring the log-in.

Aspects of the present invention provide a system, a method, and a computer readable recording medium for linking a smart TV and a smart phone using an image authentication key capable of registering the smart phone in the smart TV using the image authentication key and controlling a function of the smart TV connected with the smart phone by an application installed in the smart phone.

Aspects of the present invention provide a system, a method, and a computer readable recording medium for linking a smart TV and a smart phone using an image authentication key capable of registering the smart phone with the smart TV using the image authentication key and linking an application executed in the smart TV to a plurality of registered smart phones and executing the application.

Additional features of the invention will be set forth in the description that follows, and in part will be apparent from the description, or may be learned by practice of the invention.

According to exemplary embodiments of the present invention, there is provided a system for linking a smart TV and a user terminal using an image authentication key, including: a service server configured to generate an image authentication key comprising access information for the service server, configured to provide the image authentication key to the smart TV, and configured to provide terminal information from a user terminal to the smart TV, to link the smart TV and the user terminal; a terminal access application installed in a smart TV configured to request the image authentication key from the service server, configured to receive the image authentication key, and configured to display the received image authentication key on a screen; and a user terminal configured to scan and analyze the image authentication key displayed on the smart TV, and configured to transmit terminal information to the service server using the access information.

According to exemplary embodiments of the present invention, there is provided a service server for a connection between a smart TV and a user terminal, including: an authentication key generating unit configured to receive an image authentication key generation request from a smart TV and configured to generate an image authentication key comprising access information; an authentication key transmitting unit configured to transmit the image authentication key to the smart TV; a terminal information receiving unit configured to receive terminal information from a user terminal that scans and analyzes the image authentication key displayed on the smart TV; and a terminal information transmitting unit configured to provide the terminal information received from the user terminal to the smart TV, to set a connection between the smart TV and the user terminal.

According to exemplary embodiments of the present invention, there is provided a method for connecting a smart TV and a user terminal, including: receiving, on a service server, an image authentication key generation request from the smart TV, and generating an image authentication key comprising access information; transmitting, from the service server, the generated image authentication key to the smart TV; receiving, on the service server, terminal information comprising the access information from a user terminal scanning and analyzing the image authentication key displayed on the smart TV; and providing the terminal information received from the user terminal to the smart TV, to set a connection between the smart TV and the user terminal.

Information for providing the method for linking a smart TV and a smart phone using an image authentication key may be stored in a server computer readable recording medium. The recording medium may include all kinds of recording media in which a program and data are stored to be readable by a computer system. The recording medium may include a read only memory (ROM), a random access memory (RAM), a compact disk (CD), a digital video disk (DVD) ROM, a magnetic tape, a floppy disk, an optical data storage, or the like, and a medium implemented in a form of a carrier wave (for example, transmission through the Internet). In addition, the recording medium may be distributed in a computer system connected by a network, such that a computer readable code may be stored and executed in a distributed scheme.

It is to be understood that both the foregoing general description and the following detailed description are exemplary and explanatory and are intended to provide further explanation of the invention as claimed.

### BRIEF DESCRIPTION OF THE DRAWINGS

The above and other objects, features and advantages of the present disclosure will become apparent from the following description of certain exemplary embodiments given in conjunction with the accompanying drawings. The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a system for linking a smart television (TV) and a smart phone using an authentication key according to exemplary embodiments of the present invention.

FIG. 2 is a diagram illustrating a system for linking a set top box and a smart phone using an authentication key according to exemplary embodiments of the present invention.

FIG. 3 is a block diagram illustrating an application installed in a smart TV according to exemplary embodiments of the present invention.

FIG. 4 is a block diagram illustrating a detailed function of a service server according to exemplary embodiments of the present invention.

FIG. 5 is a block diagram illustrating an application installed in a smart phone according to exemplary embodiments of the present invention.

FIG. 6 is a block diagram illustrating a set top box according to exemplary embodiments of the present invention.

FIG. 7 is a signal flow chart illustrating a procedure for linking a smart TV and a smart phone according to exemplary embodiments of the present invention.

FIG. 8 is a signal flow chart illustrating a log-in procedure of a smart phone according to exemplary embodiments of the present invention.

FIG. 9 is a signal flow chart illustrating a smart TV control procedure of a smart phone according to exemplary embodiments of the present invention.

FIG. 10 is a signal flow chart illustrating an application linking procedure of a plurality of smart phones and a smart TV according to exemplary embodiments of the present invention.

FIG. 11A and FIG. 11B are diagrams illustrating a TV screen for linking a smart phone according to exemplary embodiments of the present invention.

FIG. 12 is a diagram illustrating a terminal information input screen in the smart phone according to exemplary embodiments of the present invention.

FIG. 13 is a diagram illustrating a TV screen for executing an application according to exemplary embodiments of the present invention.

FIG. 14 is a diagram illustrating a screen for controlling a TV in the smart phone according to exemplary embodiments of the present invention.

FIG. 15 is a diagram illustrating an execution example of an application through the plurality of smart phones and the TV according to exemplary embodiments of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Descriptions of well-known functions and constructions may be omitted for increased clarity and conciseness.

It will be understood that when an element is referred to as being “connected to” another element, it can be directly connected to the other element, or intervening elements may be present.

In the present description, a method of connecting and registering a television (TV), for example, a smart TV or a TV in which a set top box is installed, and a user terminal (for example, a smart phone) is disclosed. Particularly, in the present description, an effective registering and authenticating method using an image authentication key, for example, a quick response (QR) code, without a log-in input process through a smart TV is described. A smart TV device is either a television set with integrated Internet capabilities or a general television set connected to a set-top box for television that offers more advanced computing ability and connectivity than a basic general television set. A smart TV includes a computer system, usually from a handheld computer, integrated within a television set unit, and as such, a smart TV often allows the user to install and run more advanced applications or plugins/add-ons based on a specific platform. A smart TV runs a complete operating system or mobile operating system software providing a platform for application developers.

When a connection with a terminal using an image authentication key on a TV is executed, the TV requests a service server for an image authentication key to receive and display the image authentication key. When a user terminal to be connected scans or photographs the displayed image authentication key, terminal information is transmitted to the service server. The service server transmits the received terminal information to the TV, and the TV confirms the received terminal information and a connection between the TV and the user terminal is set.

When the connection between the TV and the user terminal is set, the user terminal may, for example, control the TV, log-in an application executed on the TV, or execute the application executed on the TV together with the user terminal, by using the connection.

An ‘image authentication key’ includes an authentication key in an image form including predetermined data. The image may be, for example, a one-dimensional barcode, a QR code, a color zip code, a smart tag, a data matrix, or the like. In some embodiments, any type of authentication key including data in an image form may be applied to the present description.

A ‘user terminal’ includes a smart phone as well as a general desktop computer, and may be a digital device including a memory unit and a microprocessor having calculation capability, such as, a mobile communication terminal, a desktop computer, a laptop computer, a workstation, a palmtop computer, a personal digital assistant (PDA), a web pad, or the like. Hereinafter, the case in which the user terminal includes a smart phone will be described by way of example in order to facilitate the understanding of the present invention.

A ‘TV’ may include any TV having any kind of form and function. Hereinafter, a smart TV having a predetermined application installed therein and having a communication function with the Internet will be described by way of example. The present invention may also be applied to a system where a set top box is connected with a general TV rather than the smart TV, and all or some of the functions implemented in the smart TV may be implemented to function in the set top box according to exemplary embodiments of the present invention. In addition, although the case in which the TV is the smart TV will be described in order to assist in the understanding of the present invention in a description to be provided below, the present invention is not limited to being applied to the smart TV, but may also be applied to any type of TV having a predetermined application installed therein to provide a network communication function.

Hereinafter, exemplary embodiments of the present invention will be described in detail with reference to the accompanying drawings so that those skilled in the art may easily implement the spirit of the present invention.

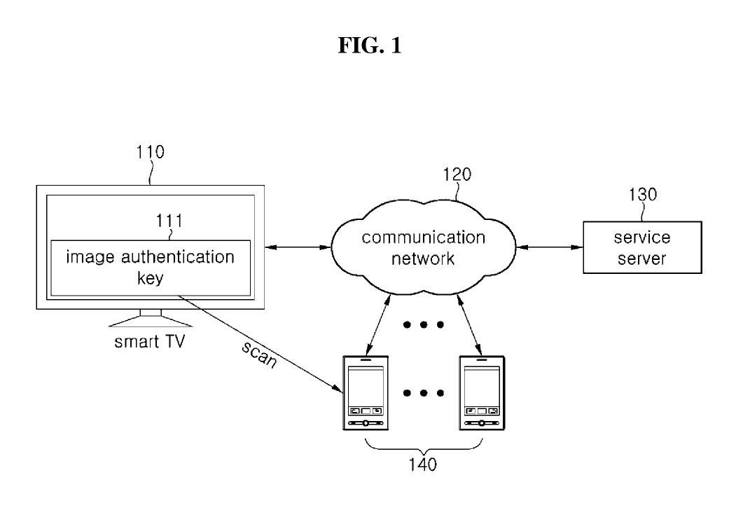

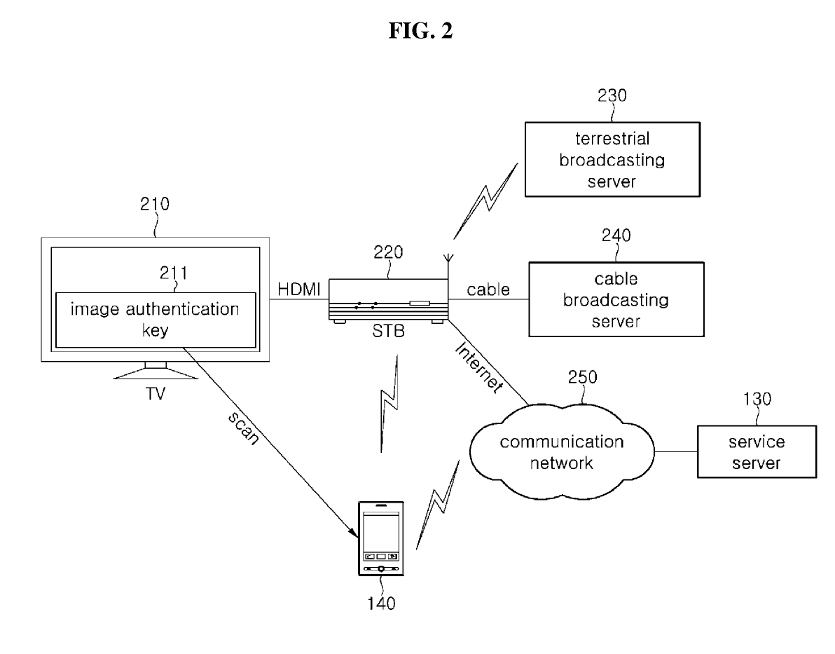

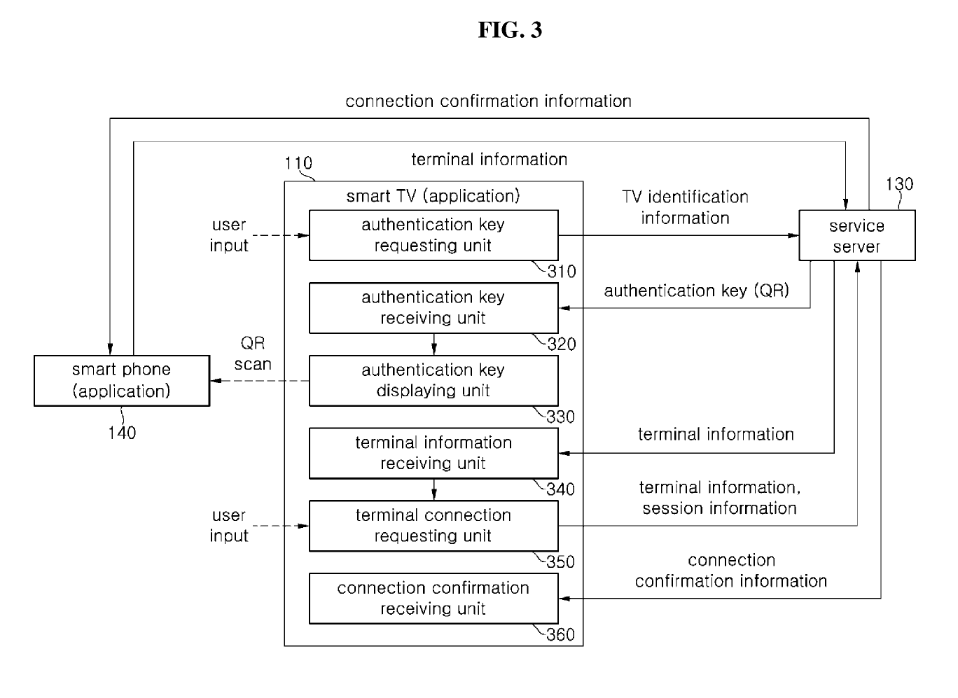

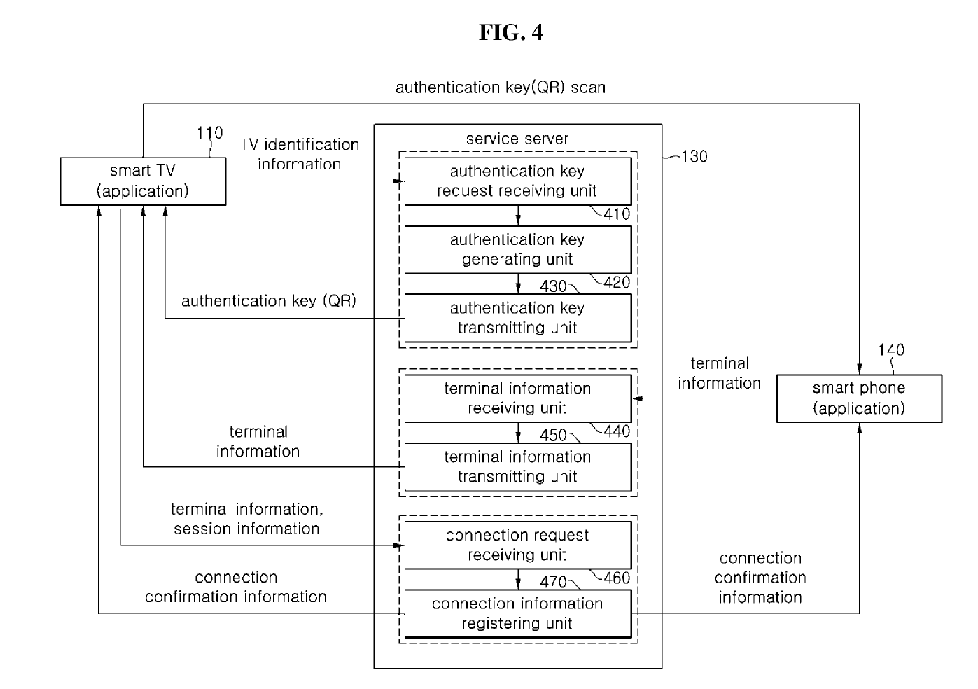

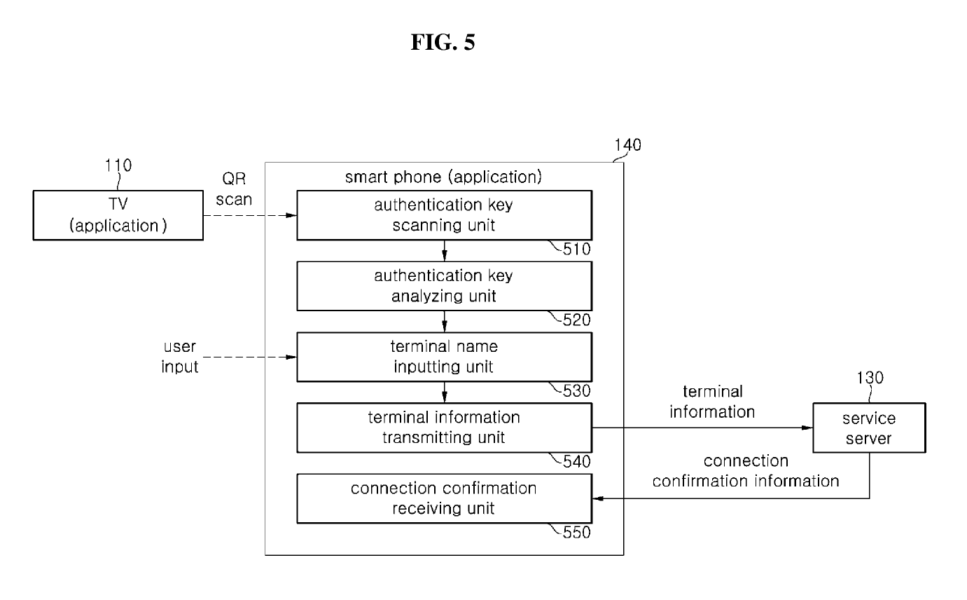

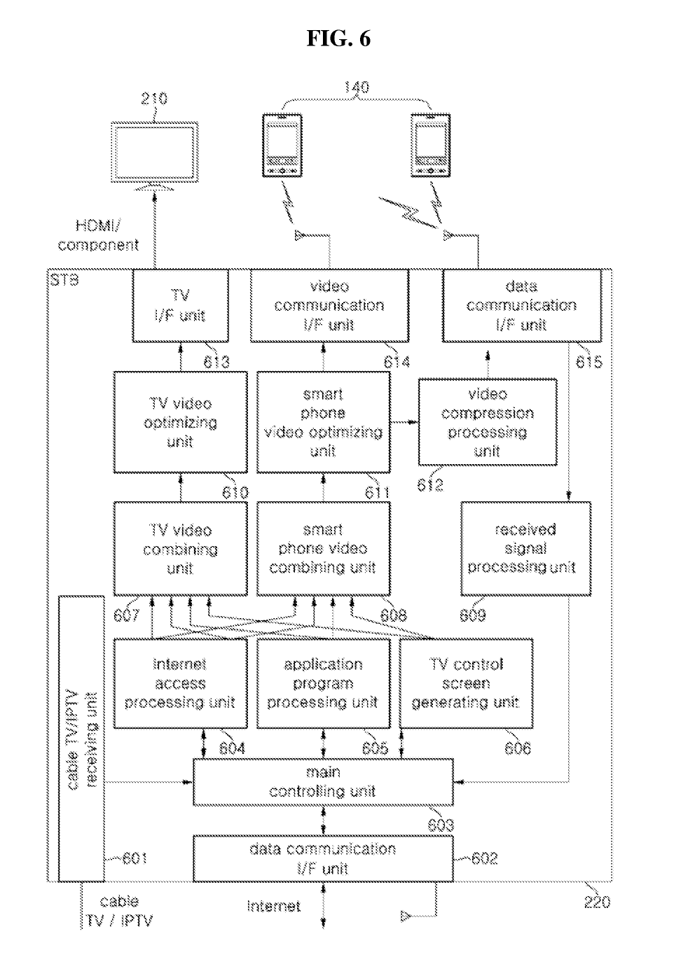

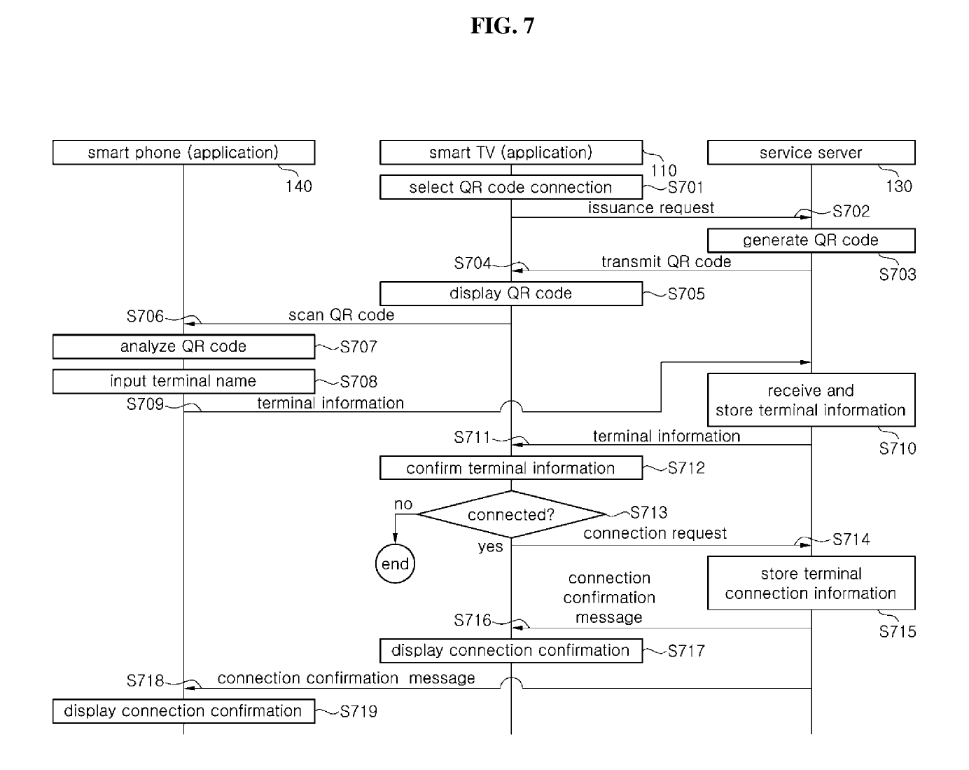

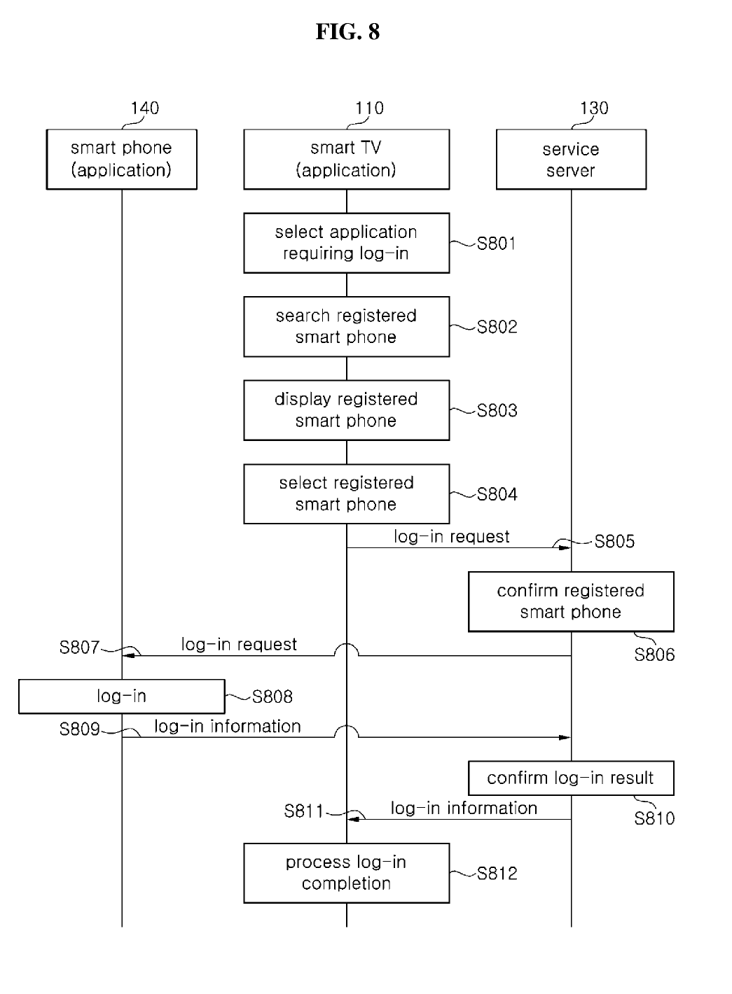

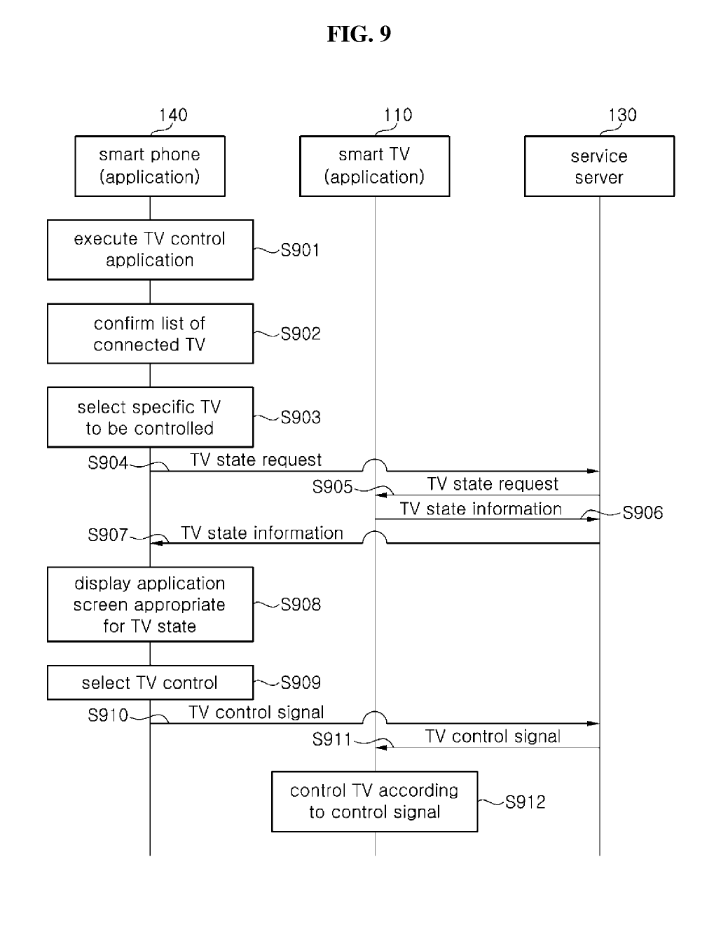

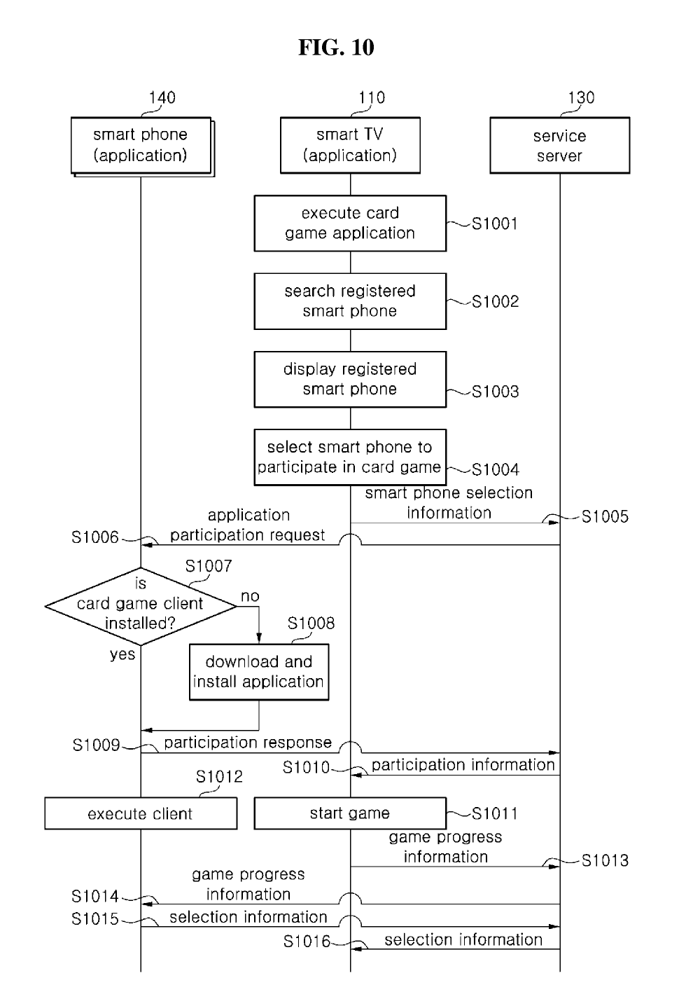

Structures of a system and an apparatus according to exemplary embodiments of the present invention will be first described with reference to FIG. 1, FIG. 2, FIG. 3, FIG. 4, FIG. 5 and FIG. 6, and a service procedure according to the exemplary embodiments of the present invention will be then described in detail with reference to FIG. 7, FIG. 8, FIG. 9 and FIG. 10.

Exemplary System for Linking TV and Smart Phone

FIG. 1 is a diagram illustrating a system for linking a TV and a smart phone using an authentication key according to exemplary embodiments of the present invention. Referring to FIG. 1, the system according to the present invention may be configured to include a smart TV 110, a communication network 120, a service server 130, at least one smart phone 140, and the like.

In some embodiments, TV linked to the smart phone 140 is the smart TV 110 that may be connected with the communication network 120. The smart TV 110 can include an application installed and executed therein. As illustrated in FIG. 2, in some embodiments a set top box can be connected with a general TV.

According to exemplary embodiments of the present invention, when a connection with the smart phone 140 is executed through a terminal connection application installed in the smart TV 110, the smart TV 110 requests the service server 130 for an image authentication key through the communication network 120. The service server 130 generates an image authentication key, for example, a QR code, unique to the smart TV 110 and provides the generated image authentication key to the smart TV 110. The terminal connection application of the smart TV 110 displays the image authentication key 111 received from the service server 130 on a screen.

Here, a user of the smart phone 140 executes an application for identifying the image authentication key installed in the smart phone 140, and photographs or scans the image authentication key 111 displayed on the smart TV 110. The application of the smart phone 140 analyzes the scanned or imaged authentication key to obtain access information to access the service server 130. According to the exemplary embodiments of the present invention, the user may input a name of the smart phone 140 to be registered in the smart TV 110 and be used by an application.

The application of the smart phone 140 requests the service server 130 for connection using the obtained access information of the service server 130 according to the analysis of the image authentication key. In this case, the name of the smart phone 140 input by the user may also be transmitted. In some embodiments, unique information through which the smart phone 140 may be recognized may also be transmitted.

The service server 130 receives connection request information from the smart phone 140, and maps to information on the smart TV 110 and stores the received information on the smart phone 140. The received information can include, for example, the name information input by the user or the unique information for identifying the smart phone 140. Then, the service server transmits the information on the smart phone 140 to the smart TV 110. The smart TV 110 receives and confirms the information on the smart phone 140 from the service server 130 and inquires whether the corresponding smart phone 140 is connected. The smart TV 110 displays a terminal information confirmation message to allow a user to confirm the connection of the corresponding smart phone 140. For example, the smart TV 110 displays the name of the smart phone 140 input by the user, and the user confirms the name of the smart phone 140 to accept the connection.

When the user confirms the information on the corresponding smart phone 140 to accept the connection, the application of the smart TV 110 again transmits the confirmation result to the service server 130 to inform the service server 130 that the connection has been is confirmed and/or confirmed.

The service server 130 receives the confirmation result from the smart TV 110, maps and registers the information on the corresponding smart phone 140 to the information on the smart TV 110, and connects the two apparatuses with each other. In some embodiments, the service server 130 transmits a message informing the smart phone 140 and/or the smart TV 110 that the connection has been confirmed to the smart phone 140 and/or the smart TV 110.

The communication network 120 may be configured over various communication technologies, such as, wired communication and wireless communication, and may include various communication networks, such as, a personal area network (PAN), a local area network (LAN), a metropolitan area network (MAN), a wide area network (WAN), or the like. The communication network 550 may be the known World Wide Web (WWW) and use a wireless transmission technology used in short range communication, such as, infrared data association (IrDA) or Bluetooth. The communication network 120 may include a cable broadcasting communication network, a terrestrial broadcasting communication network, a satellite broadcasting communication network, or the like, for receiving a broadcasting signal in the smart TV 110.

Although the smart phone 140 has been described as an example of the user terminal in FIG. 1, the user terminal may be any terminal having an input/output function for communicating with the service server 130 through the communication network 120 in order for the user to access the service server 130 to perform a connection with various TVs and having a specific application installed therein to be able to scan an image authentication key displayed on the TV, as well as the smart phone. For example, a mobile communication terminal, a desktop computer, a laptop computer, a workstation, a palmtop computer, a personal digital assistant (PDA), a web pad, or the like, may be adopted as the user terminal. However, the present invention is not limited thereto.

FIG. 2 is a diagram illustrating a system for linking a set top box and a smart phone using an authentication key according to exemplary embodiments of the present invention. Referring to FIG. 2, the system may be configured to include a TV 210, a set top box (STB) 220, a terrestrial broadcasting server 230, a cable broadcasting server 240, a communication network 250, a service server 130, and the like.

An operation implemented in the smart TV 110, as described above, may be provided through the STB 220 connected with the TV 210. The STB 220 performs a function of receiving a broadcasting signal from the terrestrial broadcasting server 230 or the cable broadcasting server 240 and providing the received broadcasting signal to the TV 210. In addition, the STB 220 includes the Internet connection function to be connected with the communication network 250, thereby communicating with the service server 130. An application implementing exemplary embodiments of the present invention may be installed in the STB 220.

According to exemplary embodiments of the present invention, when a connection with the smart phone 140 is executed on a screen of the TV 210 through a terminal connection application installed in the STB 220, the STB 210 requests the service server 130 for an image authentication key through the communication network 250. The service server 130 generates an image authentication key (for example, a QR code) unique to the STB 220 according to the request and provides the generated image authentication key to the STB 220. The terminal connection application of the STB 220 displays the image authentication key 211 received from the service server 130 on a screen of the TV 210.

When the smart phone 140 executes an application for identifying the image authentication key installed in the smart phone 140, and photographs or scans the image authentication key 211 displayed on the TV 210. The application of the smart phone 140 analyzes the photographed or scanned image authentication key to obtain access information accessible to the service server 130. In some embodiments, the user may input a name of the smart phone 140 to be registered in the STB 220 and be used with the application.

An application of the smart phone 140 requests the service server 130 for connection using the obtained access information of the service server 130 according to an analysis of the image authentication key. In this case, the name of the smart phone 140 input by the user may also be transmitted. In some embodiments, unique information through which the smart phone 140 may be recognized may also be transmitted.

The service server 130 receives connection request information from the smart phone 140, and maps and stores the received information on the smart phone 140 (for example, the name information input by the user or the unique information for identifying the smart phone 140) to information on the STB 220. Then, the service server transmits the information on the smart phone 140 to the STB 220. The STB 220 receives and confirms the information on the smart phone 140 from the service server 130 and inquires the user through the screen of the TV 210 whether or not the corresponding smart phone 140 is connected. That is, the STB 220 displays a terminal information confirmation message to allow the user to confirm the connection of the corresponding smart phone 140. For example, the STB 110 displays the name of the smart phone 140 input by the user, and the user confirms the name of the smart phone 140 to accept the connection.

When the user confirms the information on the corresponding smart phone 140 to accept the connection, the application of the STB 220 again transmits the confirmation result to the service server 130 to inform the service server 130 that the connection has been confirmed.

The service server 130 receives the confirmation result from the STB 220, maps and registers the information on the corresponding smart phone 140 to the information on the STB 220, and connects two apparatuses with each other. Finally, the service server 130 transmits a message informing the smart phone 140 and/or the STB 220 that the connection has been confirmed to the smart phone 140 and/or the STB 220.

Hereinafter, the respective components of the system described above will be described in detail.

Exemplary Smart TV Application

FIG. 3 is a block diagram illustrating an application installed in a smart TV according to the exemplary embodiments of the present invention. Referring to FIG. 3, the application installed in the smart TV 110 may be configured to include an authentication key requesting unit 310, an authentication key receiving unit 320, an authentication key displaying unit 330, a terminal information receiving unit 340, a terminal connection requesting unit 350, a connection confirmation receiving unit 360, and the like.

When the terminal connection application installed in the smart TV 110 is executed, an inquiry screen for execution of the terminal connection may be displayed. When the user selects the terminal connection by an image authentication key (for example, a QR code) in the displayed screen, the authentication key requesting unit 310 request the service server 130 for the image authentication key according to a user input signal. At the time of the request for the service server for the image authentication key, identification information (for example, identification information on a network) capable of identifying the smart TV 110 may also be transmitted. An example of the identification information of the smart TV 110 may include a serial number of the smart TV, a Media Access Control (MAC) address on the network, and the like.

The service server 130 generates an image authentication key unique to the smart TV 110 according to the request of the authentication key of the smart TV 110. The generated image authentication key includes a unique key value, which may be mapped and stored to the identification information of the smart TV 110. The image authentication key may include link information on the network accessible to the service server 130.

The image authentication key generated as described above is again transmitted to the smart TV 110, and the authentication key receiving unit 320 of the smart TV 110 receives the image authentication key and provides the received authentication key to the authentication key displaying unit 330. The authentication key displaying unit 330 displays the image authentication key on the screen of the TV.

The service server 130 transmits the terminal information received from the smart phone 140 to the smart TV 110, and the terminal information receiving unit 340 of the smart TV 110 receives the terminal information and displays the received terminal information on the screen.

The user may confirm the terminal information displayed on the screen of the smart TV 110 and select the terminal information confirmation when the terminal coincides with a terminal with which the user is to connect, thereby requesting a terminal connection. Therefore, the terminal connection requesting unit 350 of the smart TV 110 transmits the terminal information and session information to the service server 130.

The service server 130 receiving the terminal information and the session information registers the terminal information for the application to set a connection between the smart TV 110 and the smart phone 140. As described above, when the connection is set, the service server 130 transmits a connection confirmation message to the smart TV 110 and/or the smart phone 140.

The connection confirmation receiving unit 360 of the smart TV 110 may display a message informing that the connection has been completed on the screen.

Exemplary Service Server or Authentication Server

FIG. 4 is a block diagram illustrating a service server according to exemplary embodiments of the present invention. Referring to FIG. 4, the service server 130 may be configured to include an authentication key request receiving unit 410, an authentication key generating unit 420, an authentication key transmitting unit 430, a terminal information receiving unit 440, a terminal information transmitting unit 450, a connection request receiving unit 460, a connection information registering unit 470, and the like.

When the authentication key is requested from the terminal connection application installed in the smart TV 110, the authentication key receiving unit 410 of the service server 130 receives the request information and provides the received request information to the authentication key generating unit 420. The authentication key generating unit 420 generates an image authentication key (for example, a QR code) unique to the smart TV 110 according to the authentication key request. At the time of the request for the image authentication key, identification information, including identification information on a network, of the smart TV 110 may be received. An example of the identification information of the smart TV 110 may include a serial number of the smart TV, a medium access control (MAC) address on the network, and the like. The generated image authentication key includes a unique key value mapped to and stored with the identification information of the smart TV 110. The image authentication key may include link information that makes the service server 130 accessible to a user terminal on the network.

Then, the authentication key transmitting unit 430 transmits the authentication key generated by the authentication key generating unit 420 to the corresponding smart TV 110.

The terminal information input according to the scan of the image authentication key in the smart phone 140 is received by the terminal information receiving unit 440, and the received terminal information is provided to the smart TV 110. The smart TV 110 receives the terminal information and displays the received terminal information on the screen.

The user may confirm the terminal information displayed on the screen of the smart TV 110 and select the terminal information confirmation when the terminal coincides with a terminal with which the user is to connect, thereby requesting a terminal connection. The smart TV 110 may transmit the terminal information and the session information to the service server 130.

The connection request receiving unit 460 of the service server 130 receives the terminal information and the session information, and registers the terminal information for the application to set a connection between the smart TV 110 and the smart phone 140. When the connection is set, the connection information registering unit 470 of the service server 130 transmits a connection confirmation message to the smart TV 110 and/or the smart phone 140.

Exemplary Smart Phone Application

FIG. 5 is a block diagram illustrating an application installed in a smart phone according to exemplary embodiments of the present invention. Referring to FIG. 5, the application installed in the smart phone 140 may be configured to include an authentication key scanning unit 510, an authentication key analyzing unit 520, a terminal name inputting unit 530, a terminal information transmitting unit 540, a connection confirmation receiving unit 550, and the like.

When the image authentication key (for example, the QR code) is displayed on the screen of the smart TV 110, the user may execute the application of the smart phone 140. The application may drive a camera included in the smart phone 140 through the authentication key scanning unit 510 of the executed application, and may photograph or scan the image authentication key.

When the image authentication key is photographed by the authentication key scanning unit 510, the photographed image authentication key is analyzed by the authentication key analyzing unit 520. The terminal information transmitting unit 540 may request the service server 130 to authenticate using the access information of the service server 130 included in the image authentication key. The access information may be retrieved by analysis of the image authentication key by the authentication key analyzing unit 520. When, according to the exemplary embodiments of the present invention, the terminal name inputting unit 530 receives a terminal name (a nickname set by the user or the like) from the user, the terminal name inputting unit 530 transmits the received information as identification information on the smart phone 140 to the service server 130.

The service server 130 transmits the terminal information received from the smart phone 140 to the smart TV 110, and the terminal information receiving unit 340 of the smart TV 110 receives the terminal information and displays the received terminal information on the TV screen.

When a terminal confirmation procedure between the service server 130 and the smart TV 110 is completed by the transmitted terminal information and the connection between the smart TV 110 and the smart phone 140 is set by the service server 130, connection confirmation information is transmitted from the service server 130 to the smart phone 140.

The connection confirmation receiving unit 550 of the smart phone 140 receives the connection confirmation information from the service server 130 and initiates various services connected with the smart TV 110.

Set Top Box (STB)

FIG. 6 is a block diagram illustrating a set top box according to exemplary embodiments of the present invention. As described above, a function of the smart TV 110 according to the exemplary embodiments of the present invention may be similarly implemented in the STB 220.

Referring to FIG. 6, the STB 220 according to the exemplary embodiments of the present invention may be configured to include a cable TV/IPTV receiving unit 601, a data communication interface (I/F) unit 602, a main controlling unit 603, an Internet access processing unit 604, an application program processing unit 605, a TV control screen generating unit 606, a TV video combining unit 607, a smart phone video combining unit 608, a received signal processing unit 609, a TV video optimizing unit 610, a smart phone video optimizing unit 611, a video compression processing unit 612, a TV interface unit 613, a video communication interface unit 614, a data communication interface unit 615, and the like.

The cable TV/IPTV receiving unit 601 includes a broadcasting data receiving unit that may be divided into a cable TV receiving unit and an IPTV receiving unit. The cable TV receiving unit performs demodulation on a cable TV signal. In this case, data after being demodulated may include compressed video, compressed audio, and additional information. The compressed video is decompressed, for example, according to the MPEGx/H.264 standard, such that video raw data are generated. In addition, the compressed audio is decompressed, for example, according to the MPEGx/AC3/AAC standard, such that audio raw data are generated. The additional information is transmitted to the main controlling unit 603. A display screen configured of the video raw data, which is a pure TV display screen, is displayed on a display region of the TV 210.

The IPTV receiving unit receives IPTV data including compressed video, compressed audio, and additional information through the Internet. Here, the compressed video is decompressed, for example, according to the MPEGx/H.264 standard as in the cable TV receiving unit, such that video raw data are generated. In addition, the compressed audio is decompressed, for example, according to the MPEGx/AC3/AAC standard, such that audio raw data are generated. In addition, the additional information is transmitted to the main controlling unit 603. A display screen configured of the video raw data, which is a pure TV display screen, is displayed on a TV display region of the TV 210.

The data communication interface unit 602 includes a data communication channel performing separate data communication from reception of TV broadcasting contents received by the cable TV/IPTV receiving unit 601 and performs data communication with the service server 120 through the communication network 250 according to the exemplary embodiments of the present invention.

The main controlling unit 603 of the STB 220 performs various supporting functions including a connection with the service server 120 and the smart phone 140, and the like, according to the exemplary embodiments of the present invention. The main controlling unit 603 maintains the connection of the connected terminal (for example, the smart phone 140) through exchange of information with the service server 120 through the Internet access and exchanges state information with the connected terminal. A TV control command received from the connected smart phone 140 or an input signal during execution of the application is received by the received signal processing unit 609, thereby making it possible to control display setting of the TV 210 and the respective smart phones 140. The main controlling unit 603 controls a TV setting change (such as, a change of a TV channel, a volume adjustment, or the like), controls the Internet access, and control an application program provided by a content provider, such as ‘T-commerce’.

The internet access processing unit 604 controls Internet access when the Internet access to the service server 130 is performed according to the execution of the application program according to exemplary embodiments of the present invention. An internet display region is generated separately from the TV display region on the screen of the TV 210 by the internet access processing unit 604 to provide information.

The application program processing unit 605 executes various application programs processed through the connection between the TV 210 and the smart phone 140 according to the exemplary embodiments of the present invention. For example, the application program processing unit 605 performs the connection between the TV 210 and the smart phone 140 and performs a function of registering and managing the respective connection smart phones 140 and controlling the setting of the TV 210 according to a control signal from the smart phone 140. In addition, the application program processing unit 605 processes an interaction between the TV 210 and the respective smart phones 140 when the application is executed through the connection between the TV 210 and the smart phones 140.

The TV control screen generating unit 606 may generate a separate control display region for a TV channel change, a volume adjustment, a setting change, or the like, on the screen of the TV 210 and/or the screen of the smart phone 140.

The TV video combining unit 607 combines the respective display regions provided through the cable TV/IPTV receiving unit 601, the internet access processing unit 604, the application program processing unit 605, and the TV control screen generating unit 606 described above with each other in a form set by the user to generate a TV display region. The TV display region may be divided into a TV display region, an internet display region, a CP display region, a control display region, and the like, as described above or be generated so that the respective regions are partially overlapped with each other.

For example, as a form in which the respective display regions are combined with each other, the respective display regions independently are allowed to have different scales according to a preference of the user to generate a display screen for TV output or a specific display region is transparently or semi-transparently processed to generate a TV display screen.

The smart phone video combining unit 608 combines the respective display regions provided by the application program processing unit 605 and/or the TV control screen generating unit 606 with each other in a form set by the user to generate a smart phone display region to be implemented in the smart phone.

The TV video optimizing unit 610 optimizes the TV display screen to be appropriate for setting of the TV 210. In this case, various signal processing methods, such as, a scaling method, a frame rate converting method, an enhancing method, and the like, may be applied.

The smart phone video optimizing unit 611 optimizes a transmitted video to be appropriate for setting of the smart phone 140. In this case, various signal processing methods, such as, a scaling method, a frame rate converting method, an enhancing method, and the like, may be applied.

The video compression processing unit 612 performs a function of compressing raw data intended to be transmitted to the smart phone 140. A component performing decompression may be added to a terminal receiving the compressed data.

The received signal processing unit 609 performs a function of aggregating information that the user using the smart phone 140 inputs through a touch screen or an input unit. In this case, the information by the received signal processing unit 609 through the data communication interface unit 615 is transmitted to the main controlling unit to perform a function linked to the TV 210 or a function of controlling the TV 210. Although the case in which a control command from the smart phone 140 is directly transmitted to the STB 220 has been shown in FIG. 6, the control command from the smart phone 140 may also be transmitted through the service server 120 and be received to the data communication interface unit 602 of the STB 220 according to another exemplary embodiments of the present invention.

As the TV interface unit 613, which is an interface connected with the TV 210, various connection units, such as, HDMI, Component, Composite, and the like, may be used.

As the video communication interface unit 614, an interface for transmitting video raw data, WirelessHD, WirelessUSB, WirelessPCI, WiGig, or the like, may be used in order to transmit a HD signal. In this case, a downlink may be used in order to transmit video raw data, and an uplink may be used as a return channel for transmitting input information by a touch screen of the user.

The data communication interface unit 615 processes transceived data in order to provide a function linked to the smart phone 140. For example, the data communication interface unit 615 may perform communication through a local area wireless network, such as, Wi-Fi, or the like, or be implemented by any other methods.

According to the exemplary embodiments of the present invention, the application program processing unit 605 of the STB 220 may perform the respective functions of the application as described above with reference to FIG. 3, and a detailed description thereof will be omitted.

Method for Linking TV and Smart Phone

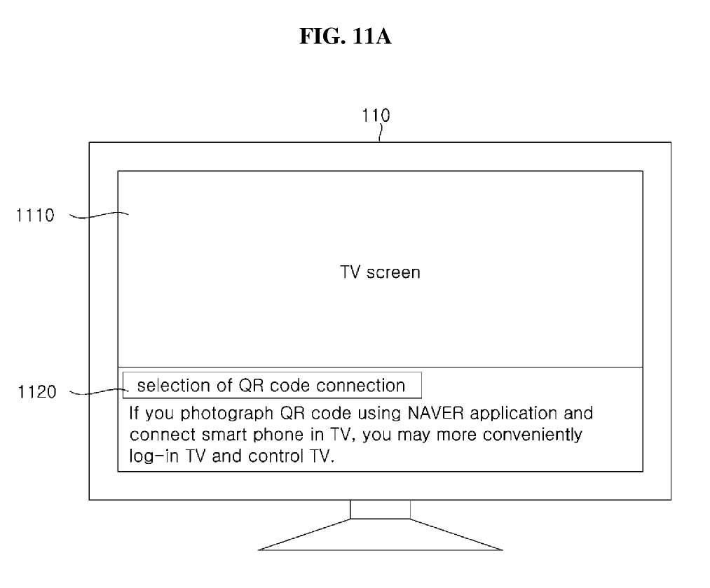

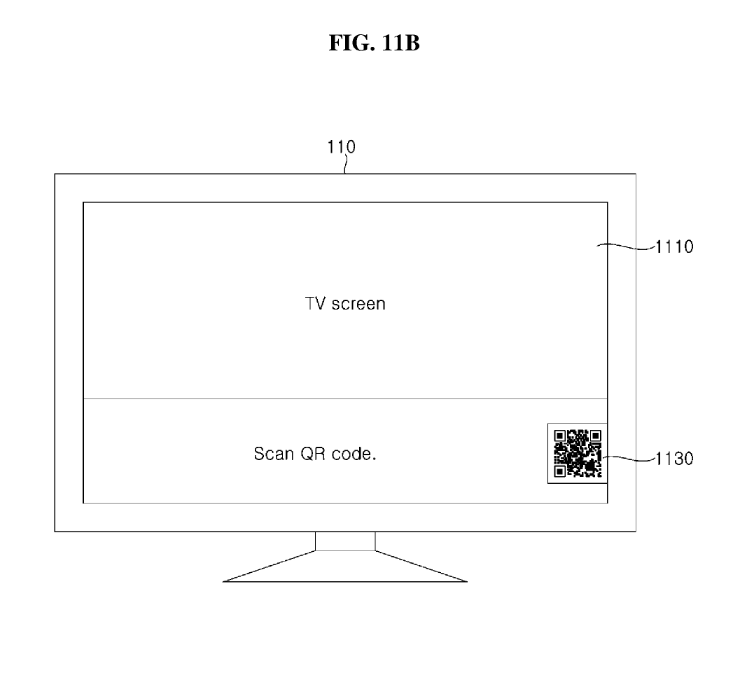

FIG. 7 is a signal flow chart illustrating a procedure for linking a TV and a smart phone according to exemplary embodiments of the present invention. Referring to FIG. 7, when the user executes the application performing the function according to the present invention in the smart TV 110, a screen for selection of QR code connection as shown in FIG. 11A may be displayed. When the user selects QR code connection (S701) through a TV remote controller, or the like, the application of the smart TV 110 requests the service server 130 to issue an image authentication key (for example, a QR code) (S702). The service server 130 generates a QR code unique to the smart TV 110 according to the request of the smart TV 110 (S703) and then transmits the generated QR code to the corresponding smart TV 110 (S704).

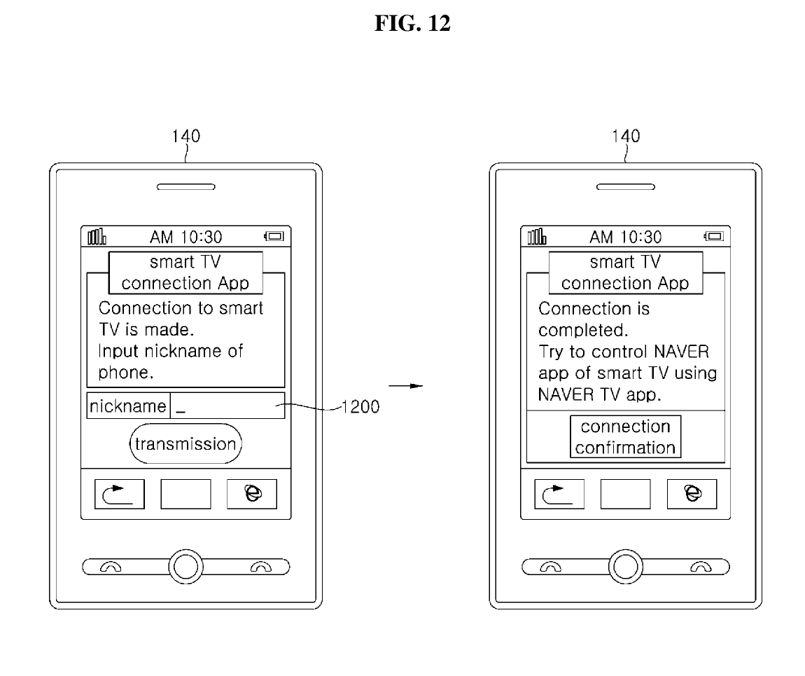

The smart TV 110 receiving the QR code from the service server 130 displays the received QR code on the screen as shown in FIG. 11B (S705). Then, the user executes the application on his/her smart phone 140 and photographs the displayed QR code to scan an image (S706). After the image is scanned, the application analyzes information included in the QR code (S707) and inputs a terminal command in a terminal name input window as shown in FIG. 12 (S708). After the terminal name is input and transmission is commanded, the input terminal information is transmitted to the service server 130 (S709).

The service server 130 receives the terminal information from the smart phone 140 and stores the terminal information (S710). Then, the service server transmits the received terminal information on the smart phone 140 to the smart TV 110 (S711). The smart TV 110 confirms the terminal information on the smart phone 140 received from the service server 130 (S712) and displays the received terminal information on the screen. The user confirms the terminal information that he/she inputs through the smart phone 140 on the screen of the smart TV 110 and requests a connection of the corresponding smart phone 140 (S713).

According to the request of the connection, the smart TV 110 requests the service server 130 for the connection of the corresponding smart phone 140 (S714), and the service server 130 registers and stores the corresponding terminal information therein (S715). As described above, when the service server 130 sets the connection between the smart TV and the smart phone 140, connection confirmation messages confirming that the connection has been completed are transmitted to the smart TV 110 and the smart phone 140 (S716 and S718). The smart TV 110 and the smart phone 140 may display messages indicating that the connection has been confirmed on their screens, respectively (S717 and S719).

Although a method of connecting one terminal (that is, one smart phone) to the TV has been described above, a plurality of terminals may be connected with and be registered in one TV. In addition, even when an application requiring log-in is executed, since the log-in may be performed for the respective registered terminals, a plurality of accounts in one TV may be used.

The system and the method for connecting a TV and a smart phone using an image authentication key according to the exemplary embodiments of the present invention have been described above. Hereinafter, examples of various services that may be provided through the connection between the TV and the smart phone will be described.

### EXAMPLES

FIG. 8 is a signal flow chart illustrating a log-in procedure of a smart phone according to exemplary embodiments of the present invention. Referring to FIG. 8, when the smart TV 110 selects an application requiring log-in (S801) in the smart phone 140 registered and connected as shown in FIG. 7, the log-in may be performed through the smart phone 140.

That is, after a specific application requiring the log-in is selected, the smart phone 140 registered in the smart TV 110 is first searched (S802). A list (of the registered smart phones for example, a father's phone, a mother's phone, a child's phone, and the like) is displayed as the search result (S803). When the user selects a specific smart phone among the registered smart phones 140 (S804), a log-in request message is transmitted together with information on the selected smart phone to the service server 130 (S805).

the service server 130 confirms whether the corresponding smart phone selected for the log-in request among the smart phones registered in the smart TV 110 has been connected (S806), according to the log-in request of the smart TV 110. When it is confirmed that the corresponding smart phone has been registered in and connected with the smart TV 110, the service server 130 confirms access information on the smart phone on the network to request the smart phone 140 for the log-in (S807).

The smart phone 140 displays a log-in input screen according to the log-in request of the service server 130. When the user inputs log-in information (for example, an identification (ID), a password, or the like) to perform the log-in (S808), the input log-in information is transmitted to the service server 130 (S809).

The service server 130 receives the log-in information from the smart phone 140 to confirm the log-in information (S810), and transmits the confirmation result or the log-in information to the smart TV 110 (S811). The smart TV 110 receives the log-in information from the service server 130, thereby performing log-in completion processing on the corresponding smart phone 140 (S812).

FIG. 9 is a signal flow chart illustrating a TV control procedure of a smart phone according to exemplary embodiments of the present invention. Referring to FIG. 9, an application installed in the TV may be controlled by the smart phone connected with the TV.

That is, when a TV control application of the smart phone 140 is executed (S901), a list of TVs connected with the smart phone 140 may be provided (S902). Then, when the user selects a specific connected TV that he/she wants to control (S903), the TV control application requests the service server 130 for state information on the selected TV (S904).

The service server 130 receives the request information from the smart phone 140 and again requests the corresponding smart TV 110 for the state information on the TV (S905). The smart TV 110 collects its state information and transmits the state information to the service server, according to the state information request of the service server 130 (S906). The service server 130 receives the state information on the TV from the smart TV 110 and provides the state information on the TV to the smart phone 140 (S907). In some embodiments, the state information may also be directly transmitted from the smart TV 110 to the smart phone 140.

As described above, the smart phone 140 receiving the state information of the smart TV 110 displays an application screen appropriate for the TV state (S908) and selects a specific control item for controlling the TV on the displayed application screen (S909). The TV control application transmits a control signal for controlling the TV to the service server 130 (S910) according to the selection of the TV control item, and the service server 130 again transmits the control signal to the corresponding smart TV 110 (S911). The smart TV 110 receives the control signal and controls the TV according to the received control signal (S912). In some embodiments, the control signal selected through the application of the smart phone 140 may be directly transmitted to the smart TV 110 without passing through the service server 130.

Therefore, the smart phone may easily control the application installed in the TV.

FIG. 10 is a signal flow chart illustrating an application linking procedure of a plurality of smart phones and a TV according to exemplary embodiments of the present invention. Referring to FIG. 10, a plurality of smart phones may simultaneously link and execute applications through the links of the smart phone and the TV. For example, a card game TV application and a plurality of smart phone users connect and register the smart phones to and in the TV, thereby making it possible to progress the card game using a link function of the smart phone and the TV. The user may confirm the entire game information, for example, an open card image, a game progress situation, and the like, through a larger TV screen, and confirm and select a card to play through their respective smart phone. Through the above-mentioned process, the user may conveniently enjoy a card game.

For example, when the smart TV 110 executes the card game application (S1001), the smart TV 110 searches for registered smart phones (S1002). When a list of registered smart phones is displayed as the search result (S1003), smart phones participating in the card game are selected (1004). Information on the selected smart phones is transmitted to the service server 130 (S1005).

The service server 130 communicates or pushes the selection information to the corresponding smart phone 140 to request the corresponding smart phone 140 to participate in the application. The smart phone 140 receiving the participation request for the card game confirms whether the corresponding application, for example, the card game client application has been installed in the smart phone 140 (S1007). When it is confirmed that the application has not been installed, the smart phone downloads the application from the corresponding server and installs the application (S1008).

When the card game client application is installed in the corresponding smart phone 140, a participation response to the corresponding game is transmitted to the service server 130 (S1009), and the service server 130 transmits participation information to the smart TV 110 (S1010).

When a card game client program corresponding to the game started by the card game application of the smart TV 110 (S1011) is executed in the smart phone 140 (S1012), the game simultaneously progresses in the smart TV 110 and the smart phone 140. The smart TV 110 and the smart phone 140 may use direct communication or indirect communication therebetween through the service server 130.

The smart TV 110 transmits game progress information to the smart phones 140 through the service server 130 (S1013 and S1014), and selection information selected during progress of the game in the respective smart phones 140 is transmitted to the smart TV 110 through the service server 130 (S1015 and S1016). For example, when a specific card is selected in a specific smart phone 140 according to execution of the card game, the card selection information may be transmitted to the smart TV 110 through the service server 130 or be directly transmitted to the smart TV 110 through direct communication with the smart TV 110. The smart TV 110 receives the card selection information from the respective smart phones 140 to reflect the card selection information in the game and executes the next process.

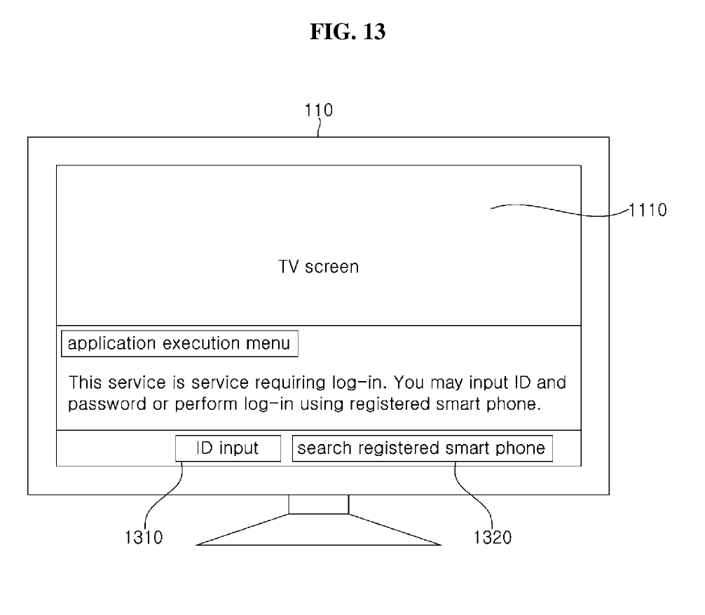

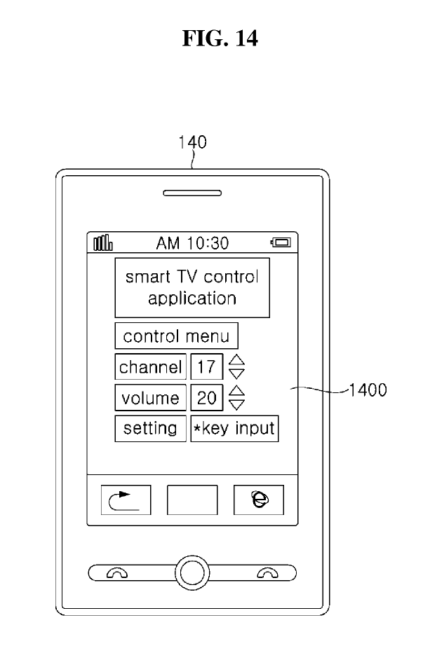

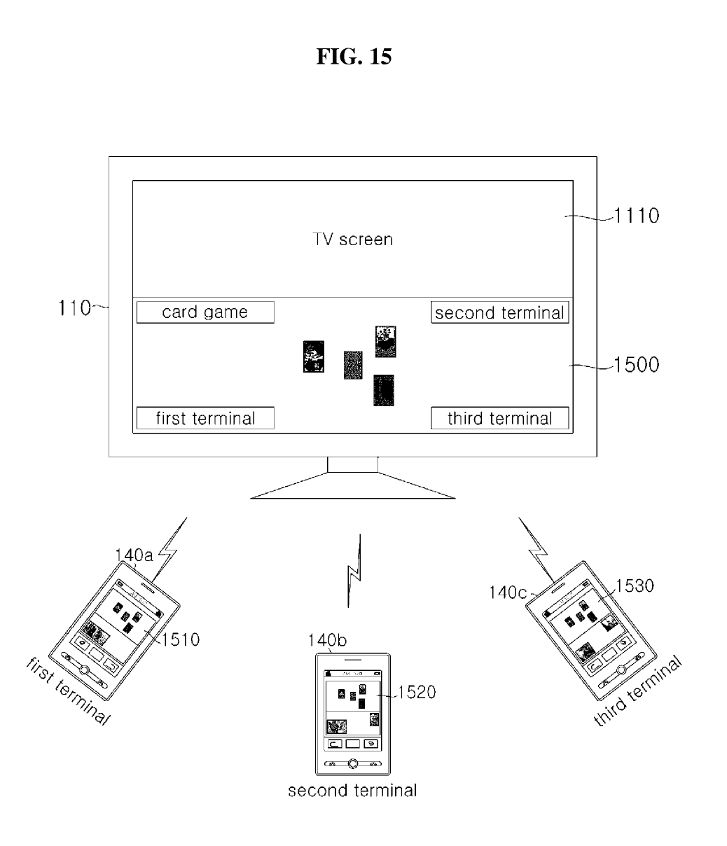

Hereinabove, the examples of various services that may be provided through the connection between the TV and the smart phone have been described with reference to FIG. 8, FIG. 9 and FIG. 10. Examples of screens actually serviced through the TV and the smart phone will be described with reference to FIG. 11A, FIG. 11B, FIG. 12, FIG. 13, FIG. 14 and FIG. 15.

FIG. 11A and FIG. 11B are diagrams illustrating a TV screen for linking a smart phone according to exemplary embodiments of the present invention. Referring to FIG. 11A, a TV screen 1110 may be displayed in a partial region on a display screen of the smart TV 110, and an application execution screen 1120 may be displayed in another partial region (for example, a lower region) of the display screen, according to exemplary embodiments of the present invention.

For example, as described above with reference to FIG. 7, when the terminal connection application is executed, a screen capable of selecting the QR code connection may be displayed, and a notice text such as ‘If you photograph a QR code using a NAVER application and connect a smart phone in a TV, you may more conveniently log-in to the TV and control the TV.’ may be displayed as shown in FIG. 11A.

In this case, when the QR code connection selection is executed, the image authentication code or QR code 1130 is received from the service server 130, such that a QR code image 1130 may be displayed as shown in FIG. 11B.

FIG. 12 is a diagram showing a terminal information input screen in the smart phone according to the exemplary embodiments of the present invention. Referring to FIG. 12, when the smart phone 140 executes a TV connection application and scans the QR code of FIG. 11B by the smart phone according to the exemplary embodiments of the present invention, a menu capable of inputting terminal information is provided as shown in FIG. 12. For example, an input blank capable of inputting a nickname 1200 may be provided. In some embodiments, when the smart phone 140 does not have a TV connection application therein, the scan of the image authentication code 1130 through a scanner application may trigger a link that includes provisions for a user to download and install the TV connection application on the smart TV 140. After installation of the TV connection application, the image authentication code 1130 may be rescanned by the TV connection application.

When the user inputs a specific name capable of identifying the terminal and selects transmission, the smart phone 140 is registered in the TV by the above-mentioned method and displays that the connection has been completed as shown by the screen on the right in FIG. 12. A message, such as, ‘Connection is completed. Try to control a NAVER application of a smart TV using a NAVER TV application.’ may be displayed.

FIG. 13 is a diagram illustrating a TV screen for executing an application according to exemplary embodiments of the present invention. Referring to FIG. 13, when an application executed in the smart TV 110 is an application requiring log-in as described above with reference to FIG. 8, a message that the application executed in the smart TV 110 requires log-in may be displayed. For example, a message such as ‘This service is a service requiring log-in. You may input an identification (ID) and a password, or perform the log-in using a registered smart phone.’ may be displayed.

In this case, the user may select an ID input 1310 to directly perform the log-in through the smart TV 110 or select a registered smart phone search 1320 to perform the log-in via a registered smart phone.

FIG. 14 is a diagram illustrating a screen for controlling a TV in the smart phone according to the exemplary embodiments of the present invention. Referring to FIG. 14, when the smart TV control application is executed by the procedure as described above with reference to FIG. 9, state information 1400 of the smart TV is displayed as shown in FIG. 14, such that the smart TV may be controlled.

For example, a channel, a volume, various settings of the smart TV may be adjusted, and various applications executed in the smart TV 110 may be controlled.

FIG. 15 is a diagram showing an execution example of an application through the plurality of smart phones and the TV according to the exemplary embodiments of the present invention. Referring to FIG. 15, when a card game is executed in the smart TV 110 by the procedure as described above with reference to FIG. 10, a plurality of smart phones (for example, a first terminal 140a, a second terminal 140b, and a third terminal 140c) and the smart TV 110 may be linked to progress the game according to the exemplary embodiments of the present invention.

Various game progress information and open card information may be provided on a card game application execution screen 1500 of the smart TV 110, and it is preferable that cards of the respective participants are not viewed.

In addition, screens 1510, 1520, and 1530 displaying the respective user's cards may be displayed on the smart phones (that is, the first terminal 140a, the second terminal 140b, and the third terminal 140c) of the respective users according to the execution of the card game client.

Therefore, the user may confirm the entire game information, an open card image, a game progress situation, and the like, through a wider TV screen and confirm and select a card possessed by him/her through his/her smart phone. Through the above-mentioned process, the user may more realistically and conveniently enjoy a card game.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system comprising:
a service server configured to generate an image authentication key comprising access information for the service server, configured to provide the image authentication key to the smart TV, and configured to provide terminal information from a user terminal to the smart TV, to link the smart TV and the user terminal;
a terminal access application installed in a smart TV configured to request the image authentication key from the service server, configured to receive the image authentication key, and configured to display the received image authentication key on a screen; and
a user terminal configured to scan and analyze the image authentication key displayed on the smart TV, and configured to transmit terminal information to the service server using the access information.

2. The system of claim 1, wherein the terminal information received from the user terimal is input with an input device, and the terminal information is configured to distinguish between user terminals linked with the smart TV.

3. The system of claim 1, wherein the user terminal is linked to multiple smart TVs, and the user terminal further comprises a control application configured to request the service server for state information of a selected one of the linked smart TVs, configured to receive the state information of the selected smart TV, and configured to control the selected smart TV.

4. The system of claim 1, further comprising an application configured to execute concurrently with mutliple user terminals, wherein when the smart TV is selected, at least one of the user terminals linked with the smart TV is selected, and the service server is configured to transmit an application participation request to the at least one of the user terminals, such that the application is executed concurrently with the at least one of selected user terminals.

5. A service server comprising:
an authentication key generating unit configured to receive an image authentication key generation request from a smart TV and configured to generate an image authentication key comprising access information;
an authentication key transmitting unit configured to transmit the image authentication key to the smart TV;
a terminal information receiving unit configured to receive terminal information from a user terminal that scans and analyzes the image authentication key displayed on the smart TV; and
a terminal information transmitting unit configured to provide the terminal information received from the user terminal to the smart TV, to set a connection between the smart TV and the user terminal.

6. The service server of claim 5, wherein the terminal information received from the terminal information receiving unit is input with an input device, and the terminal information distinguishes between user terminals connected to the smart TV.

7. The service server of claim 5, wherein the image authentication key comprises one or more of a one-dimensional barcode, a quick response (QR) code, a colorzip code, a smart tag, and a data matrix.

8. The service server of claim 5, wherein after the received terminal information is provided to the smart TV, the service server sets the connection between the smart TV and the user terminal, when a connection request message comprising a terminal information confirmation is received from the smart TV.

9. The service server of claim 8, wherein the service server transmits a connection confirmation message according to a setting of the connection to the smart TV or the user terminal.

10. The service server of claim 5, wherein when an application executed in the smart TV is an application requiring log-in, the service server selects any one user terminal among at least one user terminals set to be connected with the smart TV to receive a request for the log-in from the smart TV, and pushes the request for the log-in to a corresponding user terminal to allow the user terminal to perform the log-in.

11. The service server of claim 5, wherein the service server receives a request for state information on a smart TV selected from among at least one connected smart TV from the user terminal, according to an execution of a control application for controlling the smart TV in the user terminal, and requests state information of the selected smart TV, to allow the user terminal to control the selected smart TV.

12. The service server of claim 5, wherein when an application executed concurrently with a plurality of user terminals in the smart TV is selected, and at least one of a plurality of user terminals connected with the smart TV is selected, the service server transmits an application participation request to each selected user terminal, such that the application is executed concurrently with the selected user terminals.

13. A method for connecting a smart TV and a user terimal, the method comprising:
receiving, on a service server, an image authentication key generation request from the smart TV, and generating an image authentication key comprising access information;
transmitting, from the service server, the generated image authentication key to the smart TV;
receiving, on the service server, terminal information comprising the access information from a user terminal scanning and analyzing the image authentication key displayed on the smart TV; and
providing the terminal information received from the user terminal to the smart TV, to set a connection between the smart TV and the user terminal.

14. The method of claim 13, wherein the terminal information received from the user terminal distinguishes between a plurality of user terminals connected with the smart TV.

15. The method of claim 13, wherein the image authentication key comprises one or more of a one-dimensional barcode, a quick response (QR) code, a colorzip code, a smart tag, and a data matrix.

16. The method of claim 13, further comprising:
receiving a connection request message based on a terminal information confirmation from the smart TV after the providing of the terminal information; and
setting the connection between the smart TV and the user terminal according to the reception of the connection request message.

17. The method of claim 13, further comprising, after the setting of the connection, transmitting a connection confirmation message according to the setting of the connection to the smart TV or the user terminal.

18. The method of claim 13, further comprising:
providing a log-in to an application executed in the smart TV, by selecting a user terminal from the user terminals connected with the smart TV to receive a request for the log-in from the smart TV; and
pushing the request for the log-in to the selected user terminal,
wherein the pushing allows the user terminal to perform the log-in to the application.

19. The method of claim 13, further comprising:
receiving, from the user terminal, a request for state information from a smart TV selected from the connected smart TVs, according to execution of a control application for controlling the selected smart TV by the user terminal; and
requesting the selected smart TV for state information, to allow the user terminal to control the selected smart TV.

20. The method of claim 13, further comprising:
executing an application with one or more user terminals connected to the smart TV;
selecting at least one of the user terminals; and
transmitting an application participation request to each selected user terminal, such that the application is executed concurrently with the selected user terminals.

21. A non-transitory computer readable medium comprising an executable program which, when executed, performs a method for connecting a smart television and a user terminal, the method comprising:
receiving, on a service server, an image authentication key generation request from the smart TV, and generating an image authentication key comprising access information;
transmitting, from the service server, the generated image authentication key to the smart TV;
receiving, on the service server, terminal information comprising the access information from a user terminal scanning and analyzing the image authentication key displayed on the smart TV; and
providing the terminal information received from the user terminal to the smart TV, to set a connection between the smart TV and the user terminal.
